(19) United States
(12) Patent Application Publication
(10) Pub. No.: US 2008/0116401 A1
(43) Pub. Date: May 22, 2008

(54) Methods and Apparatus for Stabilizing a Subject Undergoing Phototherapy Treatment

(75) Inventors: Rose Marie Rice, Litchfield Park, AZ (US); Shannon D. Dawson, Phoenix, AZ (US)

Correspondence Address: JONES DAY, 222 EAST 41ST ST, NEW YORK, NY, 10017, US

(73) Assignee: PatientPatents, Inc.

(21) Appl. No.: 11/629,029

(22) PCT Filed: Jun. 14, 2005
(86) PCT No.: PCT/US05/21208

§ 371 Date: Dec. 11, 2007

Related U.S. Application Data
(60) Provisional application No. 60/579,501, filed on Jun. 14, 2004.

(51) Int. Cl. G21F 3/025

(52) U.S. Cl. 250/516.1

(57) ABSTRACT

A method of treating a subject is provided. The subject is placed in a garment or the garment is placed on the subject so as to cover a portion of the surface area of the subject with the garment. The garment is substantially transparent to a predetermined range of wavelengths. The subject is then exposed for a period of time to a light source that includes light having all or a portion of the predetermined range of wavelengths. A therapeutic clothing apparatus consisting of a blanket or hat is provided. The blanket or hat is made from a fabric that is substantially transparent to visible wavelengths.

### CROSS REFERENCE TO RELATED APPLICATION

This application claims benefit, under 35 U.S.C. § 119(e), of U.S. Provisional Patent Application No. 60/579,501 filed on Jun. 14, 2004 which is incorporated herein, by reference, in its entirety.

### 1. FIELD OF THE INVENTION

This invention relates to blankets, hats, and clothing made from material that is transparent to certain wavelengths of light and methods of using materials that are transparent to certain wavelengths of light to improve the treatment of jaundiced patients, especially newborns.

### 2. BACKGROUND OF THE INVENTION

Jaundice is a common problem in infants. This section is divided into three parts. In the first section, a description of jaundice is provided. Next, known treatment regimens are summarized. Finally, the drawbacks of known treatment regimens are outlined.

### 2.1 Neonatal Hyperbilirubinemia

Neonatal hyperbilirubinemia, defined as a total serum bilirubin level above 5 mg per dL (86 μmol per L), is a frequently encountered problem. Although up to sixty percent of term newborns have clinical jaundice in the first week of life, few have significant underlying disease. See, for example, Pediatrics 1994; 94(4 pt 1):558-62, and Jaundice and Hyperbilirubinemia in the Newborn, in Behrman et al. eds., Nelson Textbook of Pediatrics 16^{th} edition, 2000, Saunders, Philadelphia, pp. 511-28. However, hyperbilirubinemia in the newborn period can be associated with severe illnesses such as hemolytic disease, metabolic and endocrine disorders, anatomic abnormalities of the liver, and infections. In particular, high levels of bilirubin are toxic to the newborn brain. As such, hyperbilirubinemia can cause severe brain damage or death. Secondarily, hyperbilirubinemia causes the newborn's skin to turn yellow.

Up to 60 percent of term newborns have clinical jaundice in the first week of life. Jaundice typically results from the deposition of unconjugated bilirubin pigment in the skin and mucus membranes. Depending on the underlying etiology, this condition can present throughout the neonatal period. Bilirubin is the final product of heme degradation. At physiologic pH, bilirubin is insoluble in plasma and requires protein binding with albumin. After conjugation in the liver, it is excreted in bile. See, for example, Dennery et al., 2001, New England Journal of Medicine 344, pp. 581-90. Newborns produce bilirubin at a rate of approximately 6 to 8 mg per kg per day. This is more than twice the production rate in adults, primarily because of relative polycythemia and increased red blood cell turnover in neonates. See, for example, Gartner and Herschel, 2001, Pediatr Clin North Am 48, pp. 389-99. Bilirubin production typically declines to the adult level within 10 to 14 days after birth.

Physiologic jaundice in healthy term newborns generally follows a typical pattern. The average total serum bilirubin level usually peaks at 5 to 6 mg per dL (86 to 103 μmol per L) on the third to fourth day of life and then declines over the first week after birth. See, for example, Jaundice and Hyperbilirubinemia in the Newborn, in Behrman et al. eds., Nelson Textbook of Pediatrics 16^{th} edition, 2000, Saunders, Philadelphia, pp. 511-28. Bilirubin elevations of up to 12 mg per dL, with less than two mg per dL (34 μmol per L) of the conjugated form, can sometimes occur. Infants with multiple risk factors can develop an exaggerated form of physiologic jaundice in which the total serum bilirubin level may rise as high as 17 mg per dL (291 μmol per L). See, for example, Dennery et al., 2001, New England Journal of Medicine 344, pp. 581-90. Factors that contribute to the development of physiologic hyperbilirubinemia in the neonate include an increased bilirubin load because of relative polycythemia, a shortened erythrocyte life span (eighty days compared with the adult one hundred twenty days), immature hepatic uptake and conjugation processes, and increased enterohepatic circulation. See, for example, Gartner and Herschel, 2001, Pediatr Clin North Am 48, pp. 389-99.

All etiologies of jaundice beyond physiologic and breastfeeding or breast milk jaundice are considered pathologic. Features of pathologic jaundice include the appearance of jaundice within 24 hours after birth, a rapidly rising total serum bilirubin concentration (increase of more than 5 mg per dL per day), and a total serum bilirubin level higher than 17 mg per dL in a full-term newborn. Other features of concern include prolonged jaundice, evidence of underlying illness, and elevation of the serum conjugated bilirubin level to greater than 2 mg per dL or more than 20 percent of the total serum bilirubin concentration. Pathologic causes include disorders such as sepsis, rubella, toxoplasmosis, occult hemorrhage, and erythroblastosis fetalis.

### 2.2 Known Treatment Regimens

Phototherapy is a preferred method of treatment for neonatal hyperbilirubinemia by virtue of its noninvasive nature and its safety. Currently there are two forms of phototherapy—conventional and fiberoptic—used in the treatment of neonatal jaundice. A conventional phototherapy unit consists of a bank of blue and white fluorescent light bulbs that deliver visible light of 425 nm to 475 nm wavelength, at an irradiance of 4 μW/cm2/nm to 10 μW/cm2/nm, to a neonate 20 inches away. See, for example, Ennever, 1990, Clin Perinatol 17, pp. 467-487. In 1989, a fiberoptic cumberbund was introduced (The Wallaby Phototherapy System, Fiberoptic Medical Products, Inc.), which produces light similar to that of the conventional bililight. In 1990, the Ohmeda Biliblanket Phototherapy System was introduced (Ohmeda, Critical Care, Columbia, Md.). The Biliblanket system consists of a halogen lamp with an attached fiberoptic cable containing 2400 optic fibers spread out in a flat mat to deliver light at a wavelength of 400 to 500 nm. The intensity of therapeutic light delivered by the Ohmeda system can be controlled, permitting irradiance at different levels. See Rosenfeld, 1990 J Perinatol 10, pp. 243-248. The wavelengths of light delivered by any of these systems alter unconjugated bilirubin in the skin. The bilirubin is converted to less toxic water-soluble photoisomers that are excreted in the bile and urine without conjugation.

The efficacy of phototherapy depends on several factors. Porter and Dennis describe the ideal configuration as one in which four special blue bulbs (F20T12/BB) are placed centrally, with two daylight fluorescent tubes on either side. The power output of the lights (irradiance) is directly related to the distance between the lights and the newborn. See also, Maisels 1996, Pediatrics 98, pp. 283-287. Porter and Dennis teach that, in order to expose the greatest surface area, the newborn should be naked except for eye shields. For double phototherapy, the Biliblanket can be placed under the newborn in the conventional phototherapy bed.

Because phototherapy is continuous, treatment also involves significant separation of the infant and parents. With intensive phototherapy, the total serum bilirubin level typically declines by 1 to 2 mg per dL (17 to 34 μmol per L) within four to six hours. Phototherapy usually can be discontinued when the total serum bilirubin level is below 15 mg per dL.

### 2.3 Drawbacks of Known Treatment Regimens

Current phototreatment methods, while effective in treatment of jaundice, have drawbacks. Infants must spend prolonged periods of time (e.g., at least 1 hour, at least 1.5 hours, at least 2 hours, at least 2.5 hours, at least 3 hours) undergoing phototherapy. Known conventional phototherapy regimens, such as those described in Porter and Dennis 2002, American Family Physician 65, pp. 599-606, require that the infant be naked during treatment in order to maximize exposure to the specialized light. FIG. 1 illustrates how a baby is positioned under phototherapy lights 110 in order to undergo phototherapy treatment wearing just a diaper and mask 120. This naked condition causes significant discomfort to the baby undergoing treatment. This treatment is effective for treating jaundice, but may result in problems related to keeping the infant warm and comfortable. Babies have been observed to squirm and flail while undergoing treatment. In some instances this squirming is so violent that intravenous line or orogastric tubing is dislodged. To remedy this significant discomfort, sedation is often used. Such sedation is undesirable, particularly given the fact that the baby undergoing sedation and treatment is typically just a few days old. Although fiberoptic systems such as the Wallaby and Biliblanket can be used to swaddle the newborn, such systems do not instill a satisfactory amount of comfort to the baby. FIG. 2. illustrates. Although the baby is wrapped in the Biliblanket as illustrated in FIG. 2, large amounts of the newborn's skin remains exposed to air, giving rise to substantial discomfort.

In some instances, phototherapy is provided to a newborn in the home setting. However, those babies that receive phototherapy in the home setting have to be kept in warmers or incubators so that they can be unwrapped for phototherapy. The requirement for such incubators or warmers increases the complexity and cost of providing phototherapy in the home setting.

Accordingly, given the above background, what is needed in the art are apparatus and methods that comfort a baby undergoing phototherapy treatment for conditions such as jaundice that do not rely on chemically induced sedation.

### 3. SUMMARY OF THE INVENTION

The present invention provides apparatus and methods for comforting a patient, such as a baby, undergoing phototherapy treatment. The present invention provides garments that are substantially transparent in the wavelength range in which light is being administered. Prior to undergoing phototherapy treatment, the subject is wrapped in such garments. For subjects that are babies, an embodiment of the invention provide a garment in the form of a blanket that is substantially transparent to the wavelengths of light being administered. Babies often appear to be more comfortable when they are “swaddled” or wrapped in a blanket. Therefore, the blanket provides a safe environment that simulates the mother's womb, thereby decreasing stress on the infant and possibly decreasing the need for sedation and need for repeated intravenous sticks.

Wrapping an infant in a blanket also aids in thermoregulation. An infant that is wrapped is less likely to become hypothermic, and hypothermia can lead to additional complications. Using conventional phototherapy, an infant is unwrapped to allow for maximal skin exposure. Leaving an infant unwrapped necessitates placing the infant in a warmer or incubator to prevent hypothermia.

Novel garments of the present invention include blankets, hats, and clothing for the treatment of patients in need of phototherapy.

### 4. BRIEF DESCRIPTION OF THE DRAWINGS

The features and advantages of the present invention will be better understood by reference to the following detailed description, which should be read in conjunction with the accompanying drawings.

FIG. 1 illustrates an infant being treated for jaundice using phototherapy lights in accordance with the prior art.

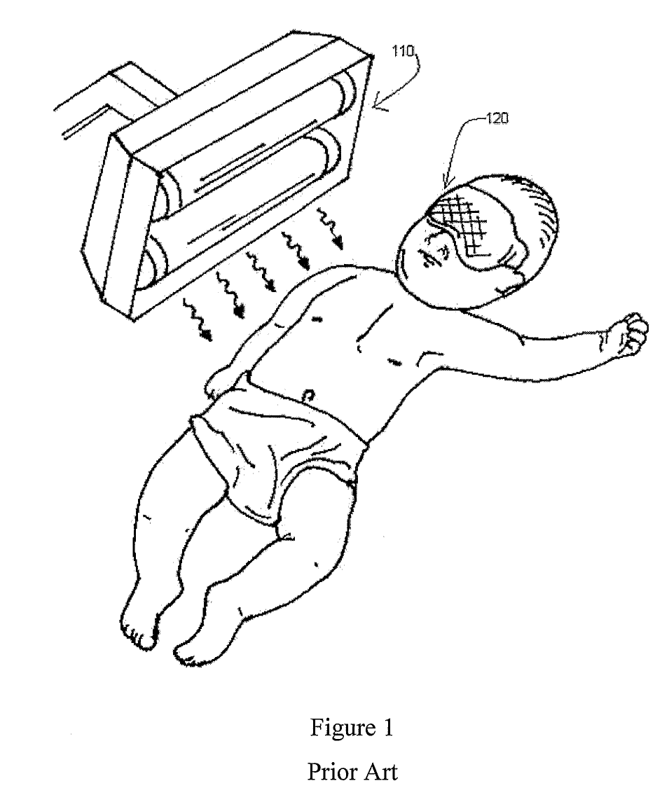

FIG. 2 illustrates how an infant is wrapped in a Biliblanket in accordance with the prior art.

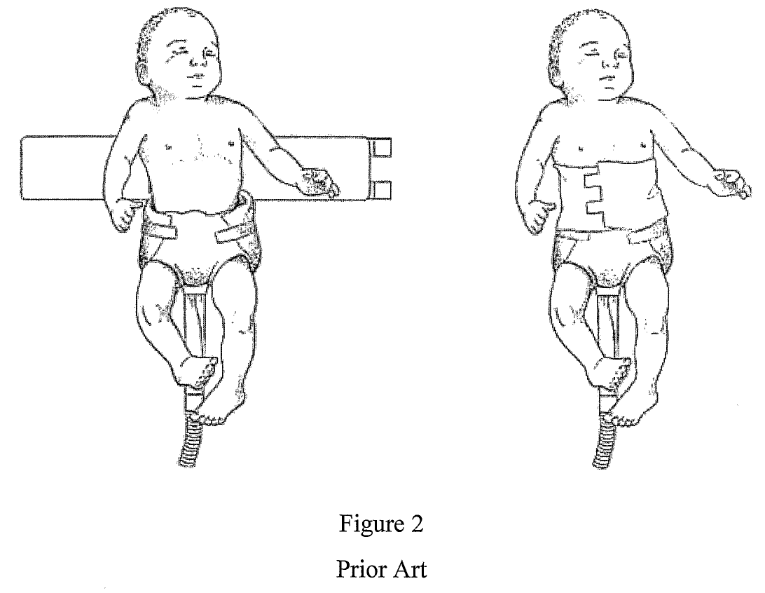

FIG. 3 illustrates an infant being treated for jaundice using a device in accordance with the present invention.

### 5. DETAILED DESCRIPTION OF THE INVENTION

The present invention provides apparatus and methods for comforting a patient, such as a baby, undergoing phototherapy treatment. In particular, the present invention provides blankets, and hats that are substantially transparent in the wavelength range in which light is being administered for phototherapy treatment.

### 5.1 Inventive Method

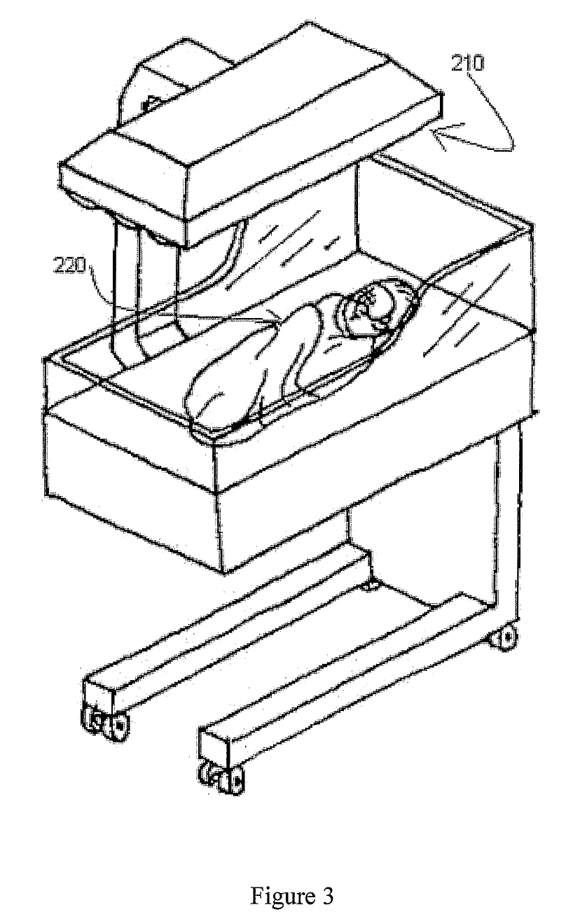

Prior to undergoing phototherapy treatment, the subject is wrapped in a blanket and/or hat of the present invention. For subjects that are babies, an embodiment of the invention provides a garment in the form of a blanket that is substantially transparent to the wavelengths of light being administered. FIG. 3 illustrates. In FIG. 3, an infant is being treated for jaundice using phototherapy lights 210 while wrapped in a blanket 220 that is substantially transparent to the wavelengths of light being applied for therapy. In one embodiment, blanket 220 allows a substantial amount of the light between the wavelengths of about 425 nm to about 475 nm to reach and treat the infant. This allows for full treatment while keeping the infant warm and comfortable. The blanket provides a safe environment that simulates the mother's womb, thereby decreasing stress on the infant and possibly decreasing the need for sedation and need for repeated intravenous sticks.

One embodiment of the present invention provides a blanket and/or hat made of a sheer material that is substantially transparent to the wavelengths of light used during phototherapy (e.g., 425-475 nm). The use of UV transparent blankets, and hats has many advantages. A blanket wrapped around the infant can make the infant feel safer, simulating the feeling of being in a mother's womb. Also, the infant will be sparred the stress of “flailing” around when naked. Additionally, blankets and hats substantially transparent to the wavelengths of light being administered significantly improve temperature control. All of these comforts will decrease the need for sedation.

### 5.2 Materials Used to Make the Inventive Apparatus

The blankets and hats of the present invention can be made out of a broad range of materials as long as they are substantially transparent to the spectrum of wavelengths that are being applied for phototherapy treatment. In one embodiment, the spectrum of wavelengths that are being applied for phototherapy treatment (treatment wavelength range) are in the wavelength range of about 425 nm to 475 nm. In some embodiments, the treatment wavelength range are those wavelengths of light delivered by daylight fluorescent lamps. In some embodiments, the treatment wavelength range is between about 400 nm and 760 nm.

In some embodiments, the blankets and hats are made out of a fabric that permits transmission of at least forty percent, at least forty-five percent, at least fifty percent, at least fifty-five percent, at least sixty percent, at least sixty-five percent, at least seventy percent, at least seventy-five percent, at least eighty percent, at least eighty-five, or at least ninety percent of the light in the treatment wavelength range. In some embodiments, the blankets and hats are made out of a fabric that permits transmission of between forty percent and ninety-nine percent, between forty-five percent and ninety percent, between fifty percent and eight-five percent, or between fifty-five percent and eighty percent of the light in the treatment wavelength range. Tests for quantifying the amount of light that a given fabric or other form of material transmits in the desired wavelength ranges is provided in Section 6 below. When quantifying the percentage of light in a given treatment wavelength range that is transmitted through a garment, the aggregate of the wavelength range is considered as done in Section 6. That is, a single value that represents the amount of light in the measured wavelength range is considered. This single value is then compared to the control case in which a subject was not protected by any garment whatsoever.

As used herein, the term fabric means a planar structure produced by interlacing yarns, fibers, or filaments. As such, the fabrics used to make the blankets and hats of the present invention include, but are not limited to, bonded fabrics (or nonwoven fabrics) consisting of a web of fibers held together with a cementing medium that does not form a continuous sheet of adhesive material, a braided fabric produced by interlacing several ends of yarns such that the paths of the yarns are not parallel to the fabric axis, a knitted fabric produced by interlooping one or more ends of yarn, and/or a woven fabric produced by interlacing two or more sets of yarns, fibers, or filaments such that the elements pass each other essentially at right angles and one set of elements is parallel to the fabric axis provided that such fabrics permits transmission of a substantial amount of the light used in the treatment wavelength range.

The fibers used to form the fabrics used to make the blankets and hats of the present invention can be inorganic fibers, natural organic fibers or synthetic organic fibers. Representative inorganic fabrics include, but are not limited to, carbon graphite fibers, such as Thornel, and zirconia fibers such as Ziercar. Representative natural organic fibers include, but are not limited to, animal fibers (e.g., wool from sheep, mohair from goats, camel's hair and silk) vegetable fibers (e.g., seed hairs such as cotton; bast fibers such as flax, hemp, jute, and ramie; and vascular fibers). In some embodiments, vegetable fibers that contain high proportions of cellulose are used. In one embodiment, mercerized cotton is used as a fiber. Mercerized cotton is cotton that has been treated with caustic soda while under tension. Examples of synthetic organic fibers that can be used in the fabrics used to make the blankets and hats of the present invention include, but are not limited to, rayons (e.g., viscose rayon, acetate rayon, cuprammonium rayon, saponified acetate rayon, high-wet modulus rayon), nylons (e.g., nylon 6,6, Nomex, and nylon 6), polyesters, acrylic fibers, modacrylic fibers, Saran, olefin fibers (e.g., polyethylenes, polypropylenes), and Teflon fibers.

In one embodiment, the fibers in the fabrics used to make the blankets and hats of the present invention are selected from the group consisting of cotton, Jute, wool, viacose, cellulose acetate, nylon, casein, flax, hemp, Sisal, Manila, Ramie, silk, Dracon, Saran, acetate rayon, polyester, polypropylene, and polytetrafluoroethylene.

In some embodiments, the fabrics used to make the blankets and hats of the present invention are make out of any of the fibers listed above wherein such fibers are either in yarn form or are not in yarn form. Yarns can be made from one or more of the fibers described above other fibers known in the art using known techniques. See, for example, Matthews-Mauersberger, The Textile Fibers, Wiley, and Von Bergen and Krauss, The Textile Atlas, Textile Book Publishers, Inc., Hess, which are hereby incorporated by reference in their entireties.

In some embodiments, the fabrics used to make the blankets and hats of the present invention are made from a yarn that is between 50 denier and 1000 denier, between 100 denier and 800 denier, between 150 denier and 500 denier, greater than 100 denier, or less than 1000 denier.

Fabrics used to make the blankets and hats of the present invention can be made with fabrics having mesh-like openings that permit visible light to shine through the fabric. For instance, in some embodiments, the fabric used to make the apparatus of the present invention have mesh openings with widths in the range between about 0.2 mm to about 10 mm, between about 0.4 mm to about 6 mm, between about 0.5 mm to about 5 mm, greater than 0.2 mm or less than about 10 mm. In some embodiments, such mesh opening adopt discrete geometrical shapes. For example, in some embodiments, the mesh-like openings are hexagonal or circular in shape. Materials that include mesh like openings are described in U.S. Pat. No. 5,518,798 to Riedel, which is hereby incorporated by reference in its entirety.

Section 6. below describes test performed on material made from a tan-through shirt manufactured by COOLWARE Company Inc. (Single Springs, Calif.). COOLWARE uses tan-through materials such as Microsol and MicrosolV. Microsol is described in U.S. Pat. No. 4,908,879 to Rogerman as a one hundred percent mercerized cotton-like fabric. Accordingly, the blankets and hats of the present invention can be manufactured using Microsol and MicrosolV.

The blankets and hats of the present invention or the fabric used to make such apparatus can be dyed any desirable color or pattern of colors provided that such garments remain substantially transparent to the wavelength range (or ranges) of light that are being administered for phototherapy treatment.

In some embodiments, a blanket of the present invention is a substantially square blanket having dimensions of between two and five feet in each of two dimensions. For example, some embodiments of the present invention provide a substantially square blanket that is substantially transparent to a predetermined range of visible wavelengths, has a first dimension between two feet and five feet in length, and a second dimension between two feet and five feet in length. Some embodiments of the present invention provide a substantially square blanket that is substantially transparent to a predetermined range of visible wavelengths, has a first dimension between two feet and four feet in length, and a second dimension between two feet and four feet in length. Some embodiments of the present invention provide a substantially rectangular blanket that is substantially transparent to a predetermined range of visible wavelengths, has a first dimension between two feet and four feet in length, and a second dimension between two feet and six feet in length.

### 6. EXPERIMENTAL

To test the novel concepts of the present invention, the light absorbance properties of a tan-though shirt (COOLWARE Company Inc., Shingle Springs, Calif.) and tested. The tan-through shirt was made out of MicrosolV. In control experiments, the light absorbance properties of a standard cotton blanket, typically used in the hospital setting, was also tested. In each experiment, the fabric under investigation was wrapped around a light sensor and then light was shown on the wrapped sensor at varying predetermined distances.

The light source used for the experiments was an Ohmeda Phototherapy II. The light system consists of a halogen lamp with an attached fiberoptic cable containing optic fibers spread out in a flat mat to deliver light at a wavelength of 400 nanometers to 500 nanometers. The light sensor was an Olympic Bili-Meter model 22 (Olympic Medical, Seattle, Wash., 98108) equipped with a sensor designed to sense light in the 425 nm to 475 nm spectral region.

Table 1 outlines the results when the light source was held 1 meter away from the sensor.

TABLE 1
Light source and light meter one meter apart.

| | Bili-Meter | |
|---|---|---|
| Material between light source and | reading | Percent |
| light sensor | (μW/cm²/nm) | Transmitted |
| No material | 6.7 | 100.0 |
| Cotton blanket - single wrap | 1.5 | 22.3 |
| Blanket made from COOLWARE shirt - | 4.9 | 73.1 |
| single wrap | | |
| Cotton blanket - double wrap | 0.4 | 5.9 |
| Blanket made from COOLWARE shirt - | 3.5 | 52.2 |
| double wrap | | |

TABLE 2
Light source and light meter 60 centimeters apart.

| | Bili-Meter | |
|---|---|---|
| Material between light source and | reading | Percent |
| light sensor | (μW/cm²/nm) | Transmitted |
| No material | 15.2 | 100.0 |
| Cotton blanket - single wrap | 3.8 | 25.0 |
| Blanket made from COOLWARE shirt - | 11 | 72.3 |
| single wrap | | |
| Cotton blanket - double wrap | 1.1 | 7.2 |
| Blanket made from COOLWARE shirt - | 8 | 52.6 |
| double wrap | | |

Tables 1 and 2 show how a blanket made from the COOLWARE shirt allows substantially more light in the desired spectral wavelength range through relative to a standard cotton blanket. For example, the singly wrapped conventional cotton blanket only allowed 22.3 percent of the available light in the desired spectral range through when the light source was held at one meter whereas the blanket made from the COOLWARE shirt allows 73.1 percent of such light through. In accordance with the present invention, a blanket with the spectral properties of the COOLWARE fabric can be used to swaddle the baby while the baby is undergoing phototherapy treatment without degradation in the effectiveness of the treatment.

### 7. REFERENCES CITED

All references cited herein are incorporated herein by reference in their entirety and for all purposes to the same extent as if each individual publication or patent or patent application was specifically and individually indicated to be incorporated by reference in its entirety for all purposes.

### 8. ALTERNATIVE EMBODIMENTS

The foregoing descriptions of specific embodiments of the present invention are presented for purposes of illustration and description. They are not intended to be exhaustive or to limit the invention to the precise forms disclosed. Obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed:

1. A method of treating a subject comprising:
placing said subject in a garment or placing said garment on said subject so as to cover a portion of the surface area of said subject with said garment, wherein said garment is substantially transparent to a predetermined range of wavelengths; and
exposing the subject for a period of time to a light source that includes light having all or a portion of said predetermined range of wavelengths.

2. The method of claim 1, wherein said garment is substantially transparent to said predetermined range of wavelengths when said garment permits at least forty percent of the light in said predetermined range of wavelengths to reach a portion of the skin of said subject that is covered by said garment.

3. The method of claim 1, wherein said garment is substantially transparent to said predetermined range of wavelengths when said garment permits at least fifty percent of the light in said predetermined range of wavelengths to reach a portion of the skin of said subject that is covered by said garment.

4. The method of claim 1, wherein said garment is substantially transparent to said predetermined range of wavelengths when said garment permits at least fifty-five percent of the light in said predetermined range of wavelengths to reach a portion of the skin of said subject that is covered by said garment.

5. The method of claim 1, wherein said garment is substantially transparent to said predetermined range of wavelengths when said garment permits at least sixty percent of the light in said predetermined range of wavelengths to reach a portion of the skin of said subject that is covered by said garment.

6. The method of claim 1, wherein said garment is substantially transparent to said predetermined range of wavelengths when said garment permits at least seventy percent of the light in said predetermined range of wavelengths to reach a portion of the skin of said subject that is covered by said garment.

7. The method of claim 1, wherein said garment is substantially transparent to said predetermined range of wavelengths when said garment permits at least eighty percent of the light in said predetermined range of wavelengths to reach a portion of the skin of said subject that is covered by said garment.

8. The method of claim 1, wherein said garment is substantially transparent to said predetermined range of wavelengths when said garment permits between forty-five percent and ninety percent of the light in said predetermined range of wavelengths to reach a portion of the skin of said subject that is covered by said garment.

9. The method of claim 1, wherein said subject is a newborn infant that has jaundice and said predetermined range of wavelengths is between about 425 nm and 475 nm.

10. The method of claim 1, wherein said predetermined range of wavelengths is between about 400 nm and 760 nm.

11. The method of claim 1, wherein said predetermined range of wavelengths is the range of wavelengths emanating from a daylight fluorescent lamp.

12. The method of claim 1, wherein said period of time is greater than two hours.

13. The method of claim 1, wherein an intensity of said light source during all or a portion of said exposing step is greater than 15 μW/cm²/nm.

14. The method of claim 1, wherein an intensity of said light source during all or a portion of said exposing step is greater than 25 μW/cm²/nm.

15. The method of claim 1, wherein an intensity of said light source during all or a portion of said exposing step is greater than 35 μW/cm²/nM.

16. The method of claim 1, wherein said garment is a blanket or a hat.

17. The method of claim 1, wherein said garment is a substantially square blanket having a first dimension between two feet and four feet in length and a second dimension between two feet and four feet in length.

18. The method of claim 1, wherein said garment is a substantially rectangular blanket having a first dimension between two feet and four feet in length, and a second dimension between two feet and six feet in length.

19. The method of claim 1, wherein said garment is made of a fabric characterized by a mesh having mesh openings with widths in the range between about 0.2 mm to about 10 mm.

20. A therapeutic clothing apparatus comprising a blanket or hat, wherein said blanket or hat comprises a fabric that is substantially transparent to light in the visible wavelength range.

21. The therapeutic clothing apparatus of claim 20 wherein said blanket or hat permits at least forty percent of light in the wavelength range of 425 nm to 475 nm to reach the portion of the skin of a subject that is covered by said therapeutic clothing apparatus.

22. The therapeutic clothing apparatus of claim 20 wherein said blanket or hat permits at least fifty-five percent of visible light in the wavelength range of 425 nm to 475 nm to reach the portion of the skin of a subject that is covered by said therapeutic clothing apparatus.

23. The therapeutic clothing apparatus of claim 20 wherein said blanket or hat permits at least seventy percent of light in the wavelength range of 425 nm to 475 nm to reach the portion of the skin of a subject that is covered by said therapeutic clothing apparatus.

24. The therapeutic clothing apparatus of claim 20 wherein said blanket or hat permits between forty-five percent and ninety percent of light in the wavelength range of 425 nm to 475 nm to reach the portion of the skin of a subject that is covered by said therapeutic clothing apparatus.

25. The therapeutic clothing apparatus of claim 20, wherein said therapeutic clothing apparatus is a substantially square blanket having a first dimension that is between two feet and five feet in length, and having a second dimension perpendicular to the first dimension that is between two feet and five feet in length.

26. The therapeutic clothing apparatus of claim 20, wherein said therapeutic clothing apparatus is a substantially square blanket having a first dimension that is between two feet and four feet in length, and a second dimension, perpendicular to said first dimension, that is between two feet and four feet in length.

27. The therapeutic clothing apparatus of claim 20, wherein said therapeutic clothing apparatus is a hat.

28. The therapeutic clothing apparatus of claim 20, wherein said fabric includes a plurality of mesh-like openings that each permits visible light through the fabric.

29. The therapeutic clothing apparatus of claim 29, wherein said plurality of mesh-like openings have widths in the range between about 0.2 mm and about 10 mm.

30. The therapeutic clothing apparatus of claim 29, wherein said plurality of mesh-like openings have widths in the range between about 0.5 mm and about 5 mm.

31. The therapeutic clothing apparatus of claim 29, wherein said plurality of mesh-like openings have widths greater than 0.2 mm.

32. The therapeutic clothing apparatus of claim 29, wherein said plurality of mesh-like openings have widths less than about 10 mm.

33. The therapeutic clothing of claim 20, wherein said fabric is made out of an organic fiber.

34. The therapeutic clothing of claim 20, wherein said fabric is made out of cotton, Jute, wool, viacose, cellulose acetate, nylon, casein, flax, hemp, Sisal, Manila, Ramie, silk, Dracon, Saran, acetate rayon, polyester, polypropylene, or polytetrafluoroethylene.
